(19) United States
(12) Patent Application Publication
(10) Pub. No.: US 2015/0034029 A1
(43) Pub. Date: Feb. 5, 2015

(54) INTERNAL COMBUSTION ENGINE HAVING AT LEAST ONE CYLINDER

(71) Applicants: Thomas Obenaus, Fernitz (AT); Helmut Melde-Tuczai, Graz (AT); Thomas Brandl, Graz (AT); Gyula Toth, Budapest (HU); Gerhard Maier, Wagersbach (AT)

(72) Inventors: Thomas Obenaus, Fernitz (AT); Helmut Melde-Tuczai, Graz (AT); Thomas Brandl, Graz (AT); Gyula Toth, Budapest (HU); Gerhard Maier, Wagersbach (AT)

(73) Assignee: AVL LIST GMBH, Graz (AT)

(21) Appl. No.: 14/128,622

(22) PCT Filed: May 24, 2012
(86) PCT No.: PCT/EP2012/059665

§ 371 Date: Jul. 15, 2014

(30) Foreign Application Priority Data
Jun. 22, 2011 (AT) A 910/2011

(51) Int. Cl. F02F 1/00; F02B 37/00; F02F 1/26

(52) U.S. Cl. CPC F02F 1/002; F02F 1/26; F02B 37/00
USPC 123/41.82 R; 123/568.13

(57) ABSTRACT

An internal combustion engine having at least one cylinder with a reciprocating piston, and in which the cylinder head and the cylinder block are integrally arranged as a head-block unit, having at least one exhaust-gas turbocharger.

### CROSS-REFERENCE TO RELATED APPLICATIONS

The present application is a National Stage Application of PCT International Application No. PCT/EP2012/059665 (filed on May 24, 2012), under 35 U.S.C. §371, which claims priority to Austrian Patent Application No. A 910/2011 (filed on Jun. 22, 2011), which are each hereby incorporated by reference in their respective entireties.

### TECHNICAL FIELD

The invention relates to an internal combustion engine, comprising at least one cylinder with a reciprocating piston, wherein the cylinder head and the cylinder block are integrally arranged as a head-block unit, having at least one exhaust-gas turbocharger.

### BACKGROUND

It is known to arrange the cylinder head and the cylinder block as a unit. Such head-block units are also known as monoblocs. An integral crankcase is usually adjacent to the head-block unit. The crankcase can also be integrated into the head-block unit.

A reciprocating internal combustion engine is shown for example in DE 28 51 179 A1, in which the cylinder head and the crankcase are integrally arranged. Further monobloc internal combustion engines are known from DE 31 23 527 A1, JP 2006-299959 A or U.S. Pat. No. 7,055,485 B1.

A spiral housing integrated in the cylinder head is known from DE 31 33 953 A1 and SE 446114 B. According to these documents, the bearing housing is inserted with the rotor of the exhaust-gas turbocharger into a cylindrical borehole with play. The spiral housing is also cast into the cylinder head for the compressor. According to this construction it is only possible to exchange gaseous media between the cylinder head and the exhaust-gas turbocharger. Reference is made in the applications to air-lubricated bearings that are to be used preferably.

It is further known to integrate exhaust-gas turbochargers in cylinder heads from the publications DE 10 2009 028 632 A1, JP 2002-303154 A2, JP 62-162728 A2, DE 31 33 953 A1 and JP 57-052624 A2.

### SUMMARY

It is the object of the invention to minimize the machining and production effort in an internal combustion engine of the kind mentioned above and to achieve an installation volume which is as compact as possible.

This is achieved in accordance with the invention such a way that at least one spiral of the exhaust-gas turbocharger is integrated into the head-block unit.

The exhaust-gas turbocharger can be arranged in the region of the cylinder head or in the region of the cylinder block, and the turbine housing can be integrated into the head-block unit.

It is preferably provided that the spiral of the exhaust-gas turbine of the exhaust-gas turbocharger is surrounded at least partly by a cooling jacket, wherein preferably the cooling jacket is integrated into the head-block unit, wherein it is especially advantageous if the cooling jacket is in connection with at least one feed channel and one discharge channel, wherein the feed and discharge channel is integrated into the head-block unit. As a result, external lines for the coolant supply of the exhaust-gas turbocharger can be avoided.

In order to keep the number of parts as low as possible, save overall space and minimize the production effort, it is especially advantageous if the shaft of the exhaust-gas turbocharger is held via plain bearings, which are connected via at least one lubricant feed channel to a lubricant circuit, wherein the lubricant supply borehole is integrated into the head-block unit. Furthermore, at least one lubricant return channel of the exhaust-gas turbocharger can be integrated into the head-block unit.

It can be provided in a further embodiment of the invention that at least one sealing-air line of the exhaust-gas turbocharger is integrated into the head-block unit.

The exhaust-gas turbocharger therefore does not comprise any external lines. All connections, lines and channels can thus be integrated into the head-block unit.

It is especially advantageous if at least one inlet collector and/or at least one outlet collector is integrated into the head-block unit. Furthermore, at least one inlet line leading to the inlet collector can be integrated into the head-block unit. The cylinder head can be sealed by a cylinder head cover, in which at least one feed line to the inlet line can be arranged in integrated manner.

The inlet lines can also be partly integrated into the head-block unit and partly housed in the cylinder head cover. The outlet lines are preferably integrated into the head-block unit.

The cylinder liners can either be incorporated integrally in the head-block unit or be screwed into said unit.

Air-lubricated bearings can be applied as an alternative to bearings lubricated by means of lubricating oil.

It is provided in an especially preferred embodiment of the invention that a bearing housing, which accommodates at least one bearing bush for bearing the shaft of the exhaust-gas turbocharger, is flanged onto the head-block unit, preferably together with the compressor of the exhaust-gas turbocharger. The number of parts can be kept within limits when the bearing housing is integrated into the compressor housing of the exhaust-gas turbocharger.

The bearing housing of the exhaust-gas turbocharger is therefore flanged onto the cylinder head of the head-block unit together with the compressor, wherein a suitable seal for sealing the pressurized oil, the coolant transfers and the discharge line of the oil and the sealing air is arranged between the head-block unit and the compressor housing.

### DRAWINGS

The invention will be explained below in closer detail by reference to the drawings, wherein:

FIG. 1 shows an internal combustion engine in accordance with the invention in a sectional view along the line I-I in FIG. 4.

FIG. 1a shows the internal combustion engine in accordance with the invention in a sectional view along the line Ia-Ia in FIG. 2 in one embodiment.

FIG. 2 shows the internal combustion engine in a sectional view along the line II-II in FIG. 1.

FIG. 3 shows the internal combustion engine in a top view.

FIG. 4 shows the internal combustion engine in a sectional view along the line IV-IV in FIG. 1.

FIG. 5 shows the internal combustion engine in a sectional view along the line V-V in FIG. 1.

### DESCRIPTION

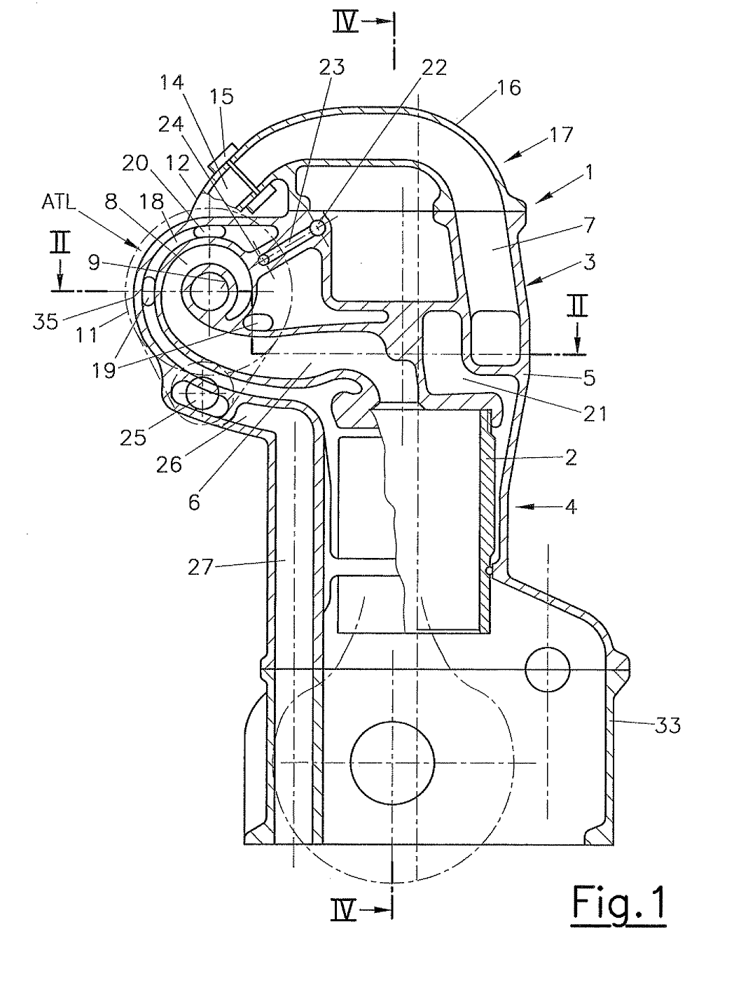

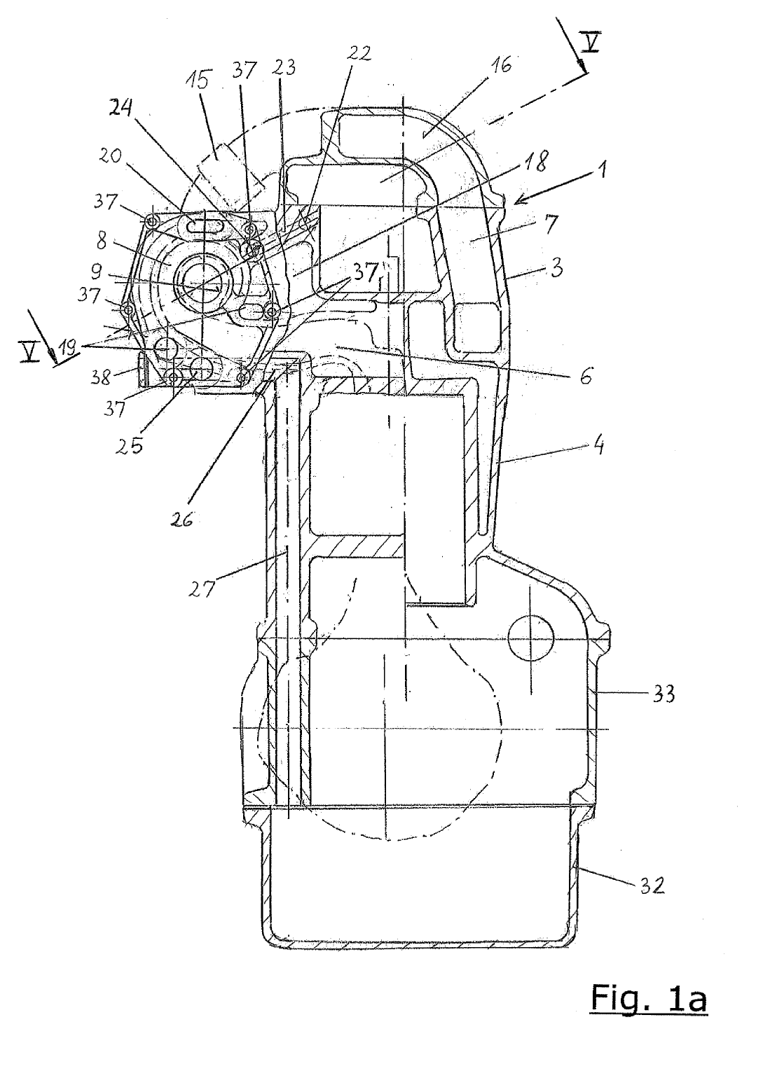

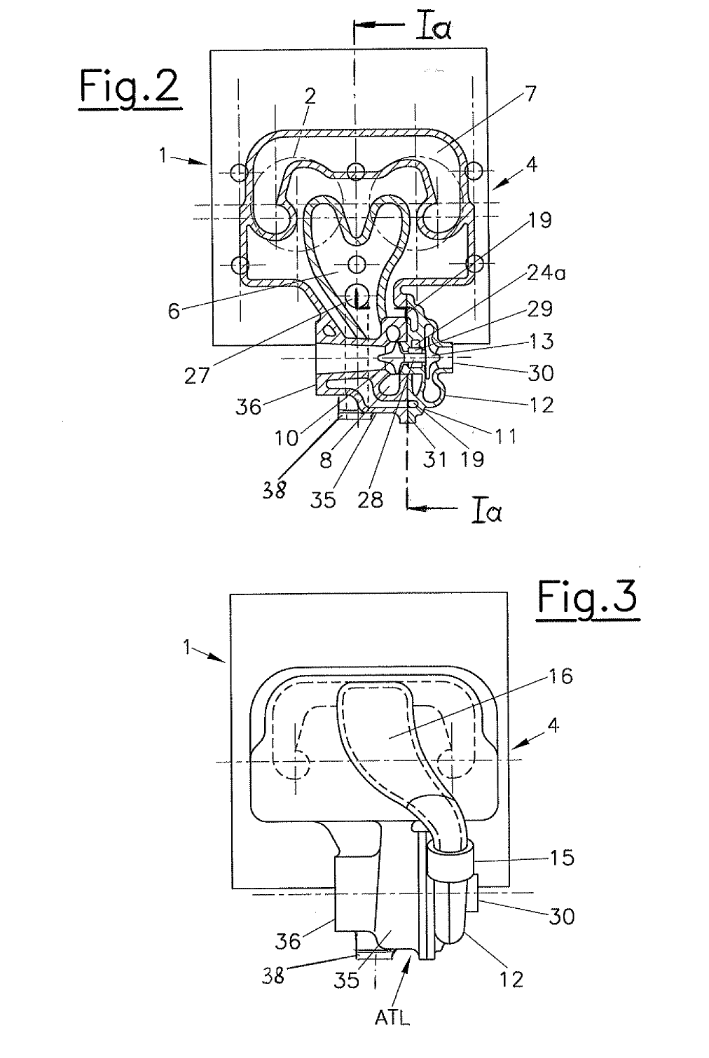

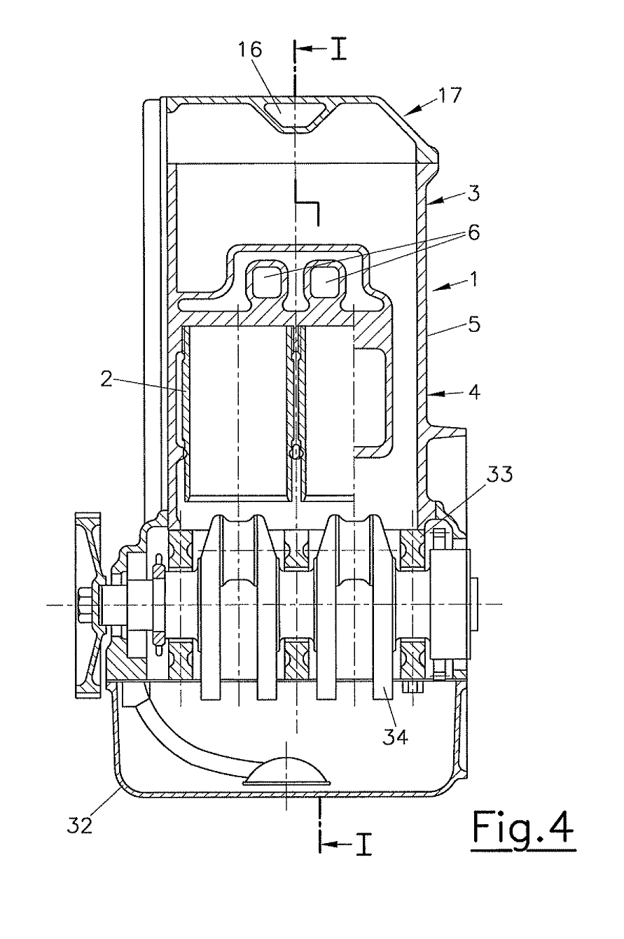

The drawings show an internal combustion engine 1 with two cylinders 2 for a respective reciprocating piston (not shown in closer detail). The cylinders 2 can also be formed by cylinder liners which are screwed in (FIGS. 1 and 4).

The internal combustion engine 1 comprises a region of the cylinder head 3 and a region of the cylinder block 4, wherein the cylinder head 3 and the cylinder block 4 are arranged as a head-block unit 5 (monobloc). A bottom part 33 of the crankcase is adjacent to the head-block unit 5.

An exhaust manifold 6 and an intake manifold 7 are cast into the head-block unit 5. A spiral 8 of the exhaust-gas turbine 10 of an exhaust-gas turbocharger ATL, which spiral is integrated into the head-block unit 5, follows the exhaust manifold 6. The turbine housing 35 of the exhaust-gas turbocharger ATL is also integrated into the head-block unit 5.

The reference numeral 9 designates the receiving borehole for the exhaust-gas turbine 10, and reference numeral 11 designates the contour of a flange-mounted compressor housing which forms a compressor spiral 12. A compressor wheel 13 is arranged in the compressor housing 11 in axial alignment with the turbine 10. The outlet 14 from the compressor spiral 12 is connected to the cast-in intake manifold 7 via a connecting hose 15 and a charge-air line 16 in the valve cover cap 17. At least the spiral 8 of the exhaust-gas turbine 10 of the exhaust-gas turbocharger ATL is surrounded at least partly by a cooling jacket 18, which is flow-connected to a cooling jacket 21 of the head-block unit 5 via at least one feed channel 19 and, at the highest point, via at least one discharge channel 20. An oil gallery 22 is arranged in the region of the cylinder head 3 of the head-block unit 5, from which a supply borehole 23 leads to a lubricant feed channel 24 to the bearing bush 29 of the shaft 28 of the exhaust-gas turbocharger ATL. Reference numeral 25 designates a transfer opening in the flange of the exhaust-gas turbocharger ATL for oil recirculation and sealing-air discharge, which transfer opening opens into the lubricant return channel 26. The lubricant return channel 26, which can optionally be drilled and can be sealed by a sealing screw 28 or a tap-hole closure, leads via the vertical part 27 of the return line back to the oil pan 32.

The bearing housing 39 of the exhaust-gas turbocharger ATL with the compressor is fixed by the screws 37 to the cylinder head 3 of the head-block unit 5. The seal 31 is pressed in this process and the lead-throughs for the cooling medium, the pressurized oil, sealing air and recirculating oil are sealed. The bearing housing 39 is advantageously arranged in an integral fashion with the compressor housing 11.

The exhaust-gas turbine 10 can be welded onto the shaft 28. The oil feed line 24 leads via the pressurized-oil borehole 24a to the bearing bush 29 of the exhaust-gas turbocharger ATL. The entrance of the air into the compressor is designated with reference numeral 30. The sealing between the compressor housing 11 and the head-block unit 5 occurs via a seal 31. The exhaust gas leaves the exhaust-gas turbocharger ATL via the exhaust-gas outlet 36.

FIG. 4 shows the oil pan designated with reference numeral 32. The crankshaft 34 is mounted several times by bearings in the bottom part 33 of the crankcase.

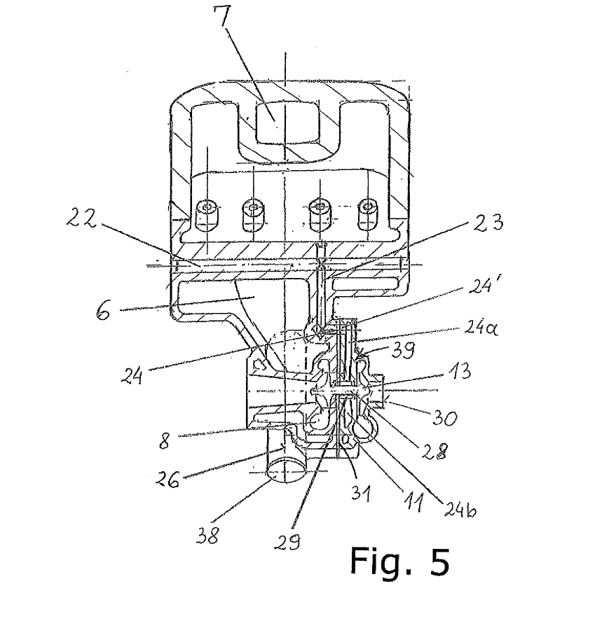

FIG. 5 shows the pressurized oil supply of the exhaust-gas turbocharger ATL from the oil gallery 22 in the cylinder head 3. The oil reaches the lubricant feed channel 24 in the cylinder head 3 via the supply borehole 23 and then passes through the seal 31 into the borehole 24′ in the bearing housing of the exhaust-gas turbocharger. Said borehole 24′ meets the pressure chamber 24a, from which the floating bearing bush 29 is supplied with oil. The oil passes through the bearing gaps and reaches the discharge chamber 24b, from where said oil reaches the transfer opening 25 together with the sealing air from the bearing housing, which transfer opening leads via the discharge channel 26 to the vertical part 27 of the return line, which finally leads to the oil pan 32.

The described construction allows a very compact internal combustion engine 1, which becomes especially cost-effective by avoiding lines to and from the exhaust-gas turbocharger ATL.

1-26. (canceled)

27. An internal combustion engine, comprising:
at least one cylinder with a reciprocating piston, wherein a cylinder head and a cylinder block are integrally arranged as a head-block unit, having at least one exhaust-gas turbocharger, wherein at least one spiral of the exhaust-gas turbocharger is integrated into the head-block unit.

28. The internal combustion engine of claim 27, further comprising a turbine housing of the exhaust gas turbocharger which is integrated into the head-block unit in a region of the cylinder head.

29. The internal combustion engine of claim 27, further comprising a turbine housing of the exhaust-gas turbocharger which is integrated into the head-block unit in a region of the cylinder block.

30. The internal combustion engine of claim 27, wherein the at least one spiral of the exhaust-gas turbocharger is surrounded at least partially by a cooling jacket.

31. The internal combustion engine of claim 30, wherein the cooling jacket is integrated into the head-block unit.

32. The internal combustion engine of claim 31, wherein the cooling jacket is in connection with at least one feed and/or discharge channel.

33. The internal combustion engine of claim 32, wherein the at least one feed and/or discharge channel is integrated into the head-block unit.

34. The internal combustion engine of claim 27, wherein a shaft of the exhaust-gas turbocharger is mounted via plain bearings, which are connected via at least one lubricant feed channel to a lubricant circuit.

35. The internal combustion engine of claim 34, wherein the at least one lubricant feed channel is integrated into the head-block unit.

36. The internal combustion engine of claim 27, wherein at least one lubricant return channel of the exhaust-gas turbocharger is integrated into the head-block unit.

37. The internal combustion engine of claim 27, wherein at least one sealing-air line of the exhaust-gas turbocharger is integrated into the head-block unit.

38. The internal combustion engine of claim 27, wherein at least one exhaust manifold is integrated into the head-block unit.

39. The internal combustion engine of claim 27, wherein at least one exhaust collector is integrated into the head-block unit.

40. The internal combustion engine of claim 27, wherein at least one intake manifold is integrated into the head-block unit.

41. The internal combustion engine of claim 27, wherein at least one intake collector is integrated into the head-block unit.

42. The internal combustion engine of claim 27, wherein a bearing housing which accommodates at least one bearing bush for bearing a shaft of the exhaust-gas turbocharger is flanged onto the head-block unit with a compressor of the exhaust-gas turbocharger.

43. The internal combustion engine of claim 42, wherein the bearing housing is integrated into a compressor housing of the exhaust-gas turbocharger.

44. The internal combustion engine of claim 43, wherein a connecting surface between the bearing housing and the head-block unit is intersected by at least one channel for guiding lubricant, coolant or sealing air.

45. The internal combustion engine of claim 44, wherein a seal to seal a channel conducting the lubricant, coolant or sealing air is arranged between the bearing housing and the head-block unit.
